(19) United States
(12) Patent Application Publication
(10) Pub. No.: US 2022/0009098 A1
(43) Pub. Date: Jan. 13, 2022

(54) METHOD AND SYSTEM OF MANUFACTURING AN INSULATED MEMBER

(71) Applicant: BASF SE, Ludwigshafen am Rhein (DE)

(72) Inventors: Tomasz CWIK, Wyandotte, MI (US); Rudi Delgas, Ludwigshafen (DE); Erik Metz, Ludwigshafen (DE)

(21) Appl. No.: 17/295,866

(22) PCT Filed: Nov. 21, 2019
(86) PCT No.: PCT/EP2019/082035

§ 371 Date: May 20, 2021

(30) Foreign Application Priority Data
Nov. 21, 2018 (EP) 18207648.9

(51) Int. Cl. B25J 9/16; B25J 11/00

(52) U.S. Cl. CPC B25J 9/1664; B25J 11/0075

(57) ABSTRACT

Described herein is a system and method of manufacturing an insulated member (500). The method includes the steps of:
providing, to a computing cloud (310), geometric data of at least a section of a raw part (501) having at least one application section to be applied with an insulation material (502),
determining, using the computing cloud (310), a movement data for a relative movement between an manufacturing-site applicator (410),
determining, using the computing cloud (310), an amount of the insulation material (502) for applying onto the application section,
generating, using the computing cloud (310), a control data set at least comprising the movement data and the amount of insulation material (502), and
providing the control data set to a manufacturing site control computer (420) site (400) that is remote to the computing cloud (310) and/or a planning site where the geometric data is generated.

The present invention is directed to cloud manufacturing of an insulated member or insulated element, respectively. In particular, the invention is directed to a method of manufacturing an insulated member, a computing cloud for manufacturing an insulated member, a manufacturing-site applicator for manufacturing an insulated member, and a system.

Insulated members can be used in many ways, for example, to achieve thermal insulation, sound insulation or the like. The field of application of such insulated members is correspondingly wide and extends, for example, to applications in numerous industries, such as construction industry, automotive industry, packaging industry etc. By way of example, such insulated members may be used as an interior trim, as an exterior wall cladding, as a construction member, as packaging material, or the like, usable in a wide range of industries.

Typically, such insulated members are manufactured manually by applying insulation material to a carrier by a manufacturing personnel. The carrier may also be referred to as a raw part, wherein the raw part provided with the applied insulation material may be referred to as the insulated member or a part of the same. In this regard, it has been found that the manual production of such an insulated element cannot only be difficult, labor-intensive and thus cost intensive, but also pose a health risk for the manufacturing personnel, for example, with regard to the materials used, which may also require a protective equipment, or the working position to be taken etc.

EP 2 533 960 B1 is directed to a method for manufacturing a pre-insulated skeleton framing segment for a building to be constructed. More specifically, it describes a method for manufacturing a pre-insulated skeleton framing segment for buildings of various dimensions. First, an assembly having at least one compartment with a hollow space which is to be filled at least partially with a foam insulation layer is received, wherein a data carrier containing data of the at least one compartment is fitted to the assembly, said data enabling a quantity of raw materials required for forming the foam insulation layer with a predetermined thickness in the at least one compartment to be determined. Then, the data carrier is read and a quantity of raw materials which are to be inserted in the at least one compartment for forming the foam insulation layer with the predetermined thickness on the basis of the data on the data carrier is determined. Further, the determined quantity of raw materials in the at least one compartment for forming the foam insulation layer with the predetermined thickness is inserted and the foam insulation layer is allowed to foam and harden in the at least one compartment during a predetermined period. As a disadvantage of this it may be regarded that a manufacturing site with a complete infrastructure has to be provided so that it must be provided centrally. In addition, it is a structure that is very specialized in terms of application.

US 2011/302877 A1 describes a centralized manufacturing system. It comprises an assembly line that comprises one or framing stations and one or more insulation stations. The frame stations are configured to build a wall frame consisting of wall studs and a covering such as drywall. The wall studs and drywall define cavities in the frame which are to be insulated. The wall section is then transferred to the insulation station. The insulation station is configured to fill the cavities in the wall frame with closed cell foam which is injected in allowable form into each cavity. After the foam is cured, the wall section is then moved to the construction site, where the house is to built-up, and used to fabricate. A drawback of such a manufacturing system is that the production of the wall sections does not take place at a site where the wall sections are used, e.g. for house construction, thus requiring an elaborate transport of the semi-finished or finished products.

Therefore, there may still be a need for providing more efficient and effective means for manufacturing an insulated member. It is accordingly an object of the present invention to provide more efficient and effective means for manufacturing an insulated member.

A first aspect of the present invention provides a method of manufacturing an insulated member or insulated element, respectively. The method may be implemented in program instructions, e.g. provided as a computer program element, and may be performed, for example, by one or more computing devices, in particular by one or more computing devices, and more particularly by one or more computing devices of a distributed computer system. Preferably, such a distributed computer system may comprise one or more computing devices, and in particular one or more of a computing cloud, a client-server system or the like, and a manufacturing site computing device, such as an edge computing device, or the like. In some embodiments, it may be contemplated that individual computation steps can be processed on different data processing units. This means that the distributed computer system may be implemented centrally via cloud computing or remotely via edge computing, or by a combination of cloud computing and edge computing. As used herein, the computing devices may be distributed to several sites remote to each other. For example, there may be a designing site, plant managing site, applicator and/or robot operating site and/or administration site, which in the following are collectively referred to as a planning site. Further, there may be a manufacturing site at which the physical manufacturing is performed and, at least in some embodiments, a computing cloud site which may also be referred to as a central site. It may be possible for one or more of the sites collectively referred to as the planning site to access or communicate with the central site.

The method of manufacturing an insulated member comprises the steps, which not necessarily need to be performed in the order listed, of:
Providing, to a computing cloud, geometric data of at least a section of a raw part having at least one application section to be applied with an insulation material.

The raw part may be also referred to as a carrier for the insulation material. The raw part provided with the insulation material may be referred to as the insulated member. The geometric data may be generated by use of one or more user interfaces associated with a computing device, e.g. the computing cloud. These user interfaces may further be associated with a planning site and may comprise user interface means for CAD design, plant management, and robot operation and/or administration tasks. The user interfaces may be executed on distributed computing devices that may also use computing resources of the computing cloud. In other words, the user interfaces may be remote from the computing cloud. In addition, the at least one user interface may be adapted to generate a geometric data output signal generated by a user's manipulation of icons, buttons etc. of the user interface.
Determining, using the computing cloud, on basis of the geometric data, a movement data for a relative movement between a manufacturing-site applicator, adapted to apply the insulation material onto the application section, and the raw part.

The applicator and the raw part may be movable relative to each other based on the determined movement data, wherein either only the applicator, only the raw part, or both the applicator and the raw part may be moved. Accordingly, there may be at least two movement data, in particular at least one movement data, e.g. instructions, adapted to control movement of the applicator, and at least one movement data, e.g. instructions, adapted to control movement of the raw part. The applicator may be provided as an automatic system, such as an industrial robot. The manufacturing site is remote to the planning site and/or the computing cloud. The manufacturing site may correspond to a construction site where the product is directly further processed, directly installed, etc. For example, the insulation member may be used directly at or near to, i.e. within a radius of a few hundred meters, the manufacturing and/or construction site to built-up a house or the like.
Determining, using the computing cloud, an amount of the insulation material for applying onto the application section.

The amount of the insulation material to be applied onto the application section may be vary between, for example, individual surface sections of the raw part. Further, the amount of insulation material may be determined based on data obtained via a user interface associated to the planning site. For example, the user interface may be adapted to generate an insulation material amount output signal generated by a user's manipulation of icons, buttons etc. of the user interface.

As used herein, a user interface may generally be adapted to provide, to a user, means for data manipulation, such as icons, buttons, selection fields, wherein manipulated data may be provided as a corresponding output signal. Further, as used herein, a user interface may generally be adapted to provide a graphical display of data provided to the user interface as an input signal generated by the computing cloud and/or the manufacturing site. The graphical display may comprise means for visualization of data, such as a progress bar etc., highlighting data, or the like.

Generating, using the computing cloud, a control data set at least comprising the movement data and the amount of insulation material.

Generating the control data set may comprise one or more computing processes and may be based on the geometric data, for example, obtained via one or more user interfaces associated to the planning site. The control data set may include one or more of the output signals generated by the user by use of the one or more user interfaces.
Providing the control data set to be available for a manufacturing site data interface applicator.

The control data set may be directly or indirectly transferred to the manufacturing site. The control data set may be provided via a data interface which may be connectable to or connected to a network communication system.

By this configuration, efficient and effective means for manufacturing an insulated member may be provided. In particular, the manufacturing process may be more reliable, simple and cost efficient due to direct integration of construction information. Further, the method may be performed by computing resources by the computing cloud. Furthermore, as the method may be performed cloud-based it may thus be provided scalable and particularly flexible. All steps of manufacturing may be carried out essentially simultaneously via the computing cloud. Thus, an automatic, cloud-based manufacturing system may be provided.

In an embodiment, the method may further comprise the step of controlling, by the computing cloud or a control computer, of the relative movement between the applicator, such as an application robot, and the raw part and of the application of the insulation material on basis of the control data set. For this purpose, the control computer may be at least temporarily data connected to the computing cloud to obtain the control data set. Thus, application of the insulation material onto the raw part may be performed automatically, on a remote site.

In another embodiment, using the computing cloud, the required amount of insulation material may be determined based on a desired insulation value of the finalized insulated member. For this purpose, the desired insulation value, which may be referred to as R-value indicating how well the insulated member resists conductive flow of heat, may be provided via a user interface associated with the planning site. For example, the required amount of insulation material may be provided as a signal generated by use of one or more user interfaces. The user interface may be adapted to generate an insulation material amount output signal generated by a user's manipulation of icons, buttons etc. of the user interface. Thus, the required amount can be automatically determined, based on a practically relevant value, so that further tests on the manufactured insulated member are unnecessary.

According to an embodiment, via at least one user interface associated with the computing cloud, the insulation value and/or an insulation material type may be to be input, wherein the computing cloud determines an insulation material thickness required on basis of the input insulation value and/or insulation material type. The user interface, which may be associated with the planning site, may provide one or more data input fields and/or data selection fields, such as icons, buttons etc., associated to the insulation value and/or an insulation material type.

The user interface may be adapted to, in response to a user's manipulation of the at least one data input field and/or data selection field, generate an output signal comprising information about the insulation value and/or an insulation material type. This may provide an intuitive way to configure the insulation value without the need for manual calculations with respect to material properties etc.

In an embodiment, using the computing cloud, an area size of the application section may be determined. For this purpose, the geometric data may be processed by the cloud. Thus, determining the required amount of insulation material may be further improved.

According to a further embodiment, using the computing cloud, a number of application layers of the insulation material applied to the application section may be determined. For this purpose, the geometric data may be processed by the cloud. Thus, determining the required amount of insulation material may be further improved.

In an embodiment, the control data set may be queued in the computing cloud, and wherein, via a user interface associated with the computing cloud, an order and/or content of the queue comprising at least one further data set is changeable. The user interface may be a job planning interface, which may be further associated with the planning site, adapted to list one or more individual jobs, each of which is associated with a corresponding control data set. The user interface may be adapted to generate an output signal in response to a user's manipulation of one or more icons, buttons etc. of the user interface. In particular based on the output signal the user interface may be adapted to instruct the computing cloud to change the order and/or content of the individual jobs or the individual control data sets, respectively. Likewise, the computing cloud may be adapted to generate a corresponding signal comprising the changed order to be displayed in a graphical display of the user interface. Further, the computing cloud may be adapted to provide the individual control data sets in the accordingly changed order to be available for the manufacturing site, e.g. the applicator and/or the control computer and/or the application robot. Thus, flexibility of manufacturing may be further improved.

According to a further embodiment, the queue may be associated to a user interface associated to the planning site, in particular to the plant managing site or the applicator and/or robot operating site. The user interface may be adapted to allow manipulating the content and/or order of the queue by user manipulation operations, such as dragging and dropping individual entries of the queue, and to generate an output signal comprising the queue data. Likewise, the computing cloud and/or the control computer may be adapted to process the output signal to adapt the content and/or order included in the output signal.

In an embodiment, using the computing cloud and/or the control computer, a total amount of insulation material required may be estimated, predicted or determined on basis of the queue. In other words, the queue may comprise one or more individual jobs, each of which is associated with a corresponding control data set, wherein the respective control data set comprises data indicating the required amount of insulation material for the individual job, and wherein the computing cloud is adapted to sum up the partial amounts associated to the individual jobs to the total amount.

In a further embodiment, the estimated, predicted or determined total amount of insulation material may be provided to the planning site, e.g. to a user interface associated with the planning site. For example, the computing cloud and/or the control computer may be adapted to generate a corresponding output signal, which may be processed so as to generate a graphical display showing the estimated, predicted or determined total amount of insulation material. Thus, a feedback may be provided from the cloud and/or the manufacturing site to the planning site.

According to a further embodiment, estimating, predicting or determining of the total amount of insulation material required may be performed by use of a machine learning algorithm. The machine learning algorithm may be trained on the basis of one or more training data sets, which in particular may comprise historical data collected at e.g. the manufacturing site. The historical data may comprise, for example, geometric data, performance values, such as the desired insulation value, an amount of insulation material associated with the desired insulation value etc.

In an embodiment, using the computing cloud, a total processing time of at least applying the insulation material onto the application section may be estimated, predicted or determined on basis of the queue. In other words, the queue may comprise one or more individual jobs, each of which is associated with a corresponding control data set, wherein the respective control data set comprises data indicating the required processing time for the individual job, and wherein the computing cloud is adapted to sum up the partial processing times associated to the individual jobs to the total processing time. For example, the required processing time may be determined based on the obtained geometric data, the type of applicator, wherein different speeds, etc. may be possible for different types, etc.

In a further embodiment, the estimated, predicted or determined total processing time may be provided to the planning site, e.g. to a user interface associated with the planning site. For example, the computing cloud and/or the control computer may be adapted to generate a corresponding output signal which may be processed so as to generate a graphical display adapted to display the estimated, predicted or determined total processing time. Thus, a feedback may be provided from the cloud and/or the manufacturing site to the planning site.

According to a further embodiment, estimating, predicting or determining of the total processing time required may be performed by use of a machine learning algorithm. For this purpose, the machine learning algorithm may be trained by use of one or more training data sets.

According to an embodiment, the method further comprises that during application of the insulation material process data may be collected in a process data set by a manufacturing site process monitoring means. The manufacturing site process monitoring means may comprise one or more detection means, e.g. an optical detection means, such as a camera, IR camera etc., or the like. Thus, a feedback comprising process data, in particular with respect to the application of the insulation material, may be provided by the manufacturing site.

In a further embodiment, the process data set may be provided to the planning site, e.g. to a user interface associated with the planning site. For example, a number of parameters from the detection means, such as a camera, from safety locks, and other equipment may be displayed in a graphical equipment overview user interface. For example, the user interface and/or a computing device associated therewith may be adapted to generate data to be displayed based on the process data set. Thus, at the planning site process data may be monitored, e.g. in real-time, based on the process data set collected at the remote manufacturing site.

According to an embodiment, an amount of the insulation material already applied onto the application section may be determined dynamically on basis of the process data set. This amount may in particular be determined by the computing cloud. Thus, a feedback regarding an amount of the insulation material already applied onto the application section may be provided by the manufacturing site.

In a further embodiment, the determined amount of the insulation material already applied onto the application section may be provided to the planning site, e.g. to a user interface associated with the planning site. For example, the dynamically determined amount may be displayed in the user interface, e.g. in a user interface associated with plant management and/or applicator operation. For this purpose, the computing cloud and/or the control computer and/or a computer device, associated with the user interface may be adapted to generate a graphical display to be displayed in the user interface, comprising e.g. a progress bar that indicates the current progress of application based on the expected total amount.

According to an embodiment, utilization and/or costs of the insulation material applied to the application section may be determined dynamically on basis of the process data set. This amount may in particular be determined by the computing cloud. Thus, a feedback regarding utilization and/or costs of the insulation material applied to the application section may be provided by the manufacturing site.

In a further embodiment, the utilization and/or costs may be provided to the planning site, e.g. to a user interface associated with the planning site, e.g. to a user interface associated with the plant management. For example, the user interface may display the real-time cost per each job corresponding to the respective control data set. Thus, a manufacturer of the insulated member may be informed dynamically about the costs.

In an embodiment, using the computing cloud, a material logistics system may be triggered to order a stock quantity of material. The material stock may comprise the raw part, the insulation material, or other supplies that are used during manufacturing. Thus, a reliable, continuous manufacturing line can be provided. Further, an automatic system may be provided that is adapted to track material usage and to order it automatically when needed.

According to an embodiment, the computing cloud comprises an artificial-intelligence-module, AI-module, wherein the AI-module performs at least determination tasks and/or estimation tasks of the computing cloud. The AI-module may comprise one or more models, in particular one or more data driven models. Further, the AI-module and/or the at least one model may comprise one or more artificial neural networks, to which e.g. the process data set provided by the manufacturing site may be provided as input data, and which may be adapted to analyze, predict, determine or the like whether the application process of the applied insulation material complies with predetermined requirements. The AI-module may be adapted to provide such results as an output signal to the planning site, in particular to the plant management user interface to be graphically displayed. Accordingly, the plant management user interface may be adapted to generate a graphical display in response to the output signal of the AI-module. For example, such a graphical display may be provided as a dashboard and may comprise information associated with the application process, such as utilization of the raw part, e.g. showing how many parts have been produced during a certain time period, e.g. per minute, how much the applicator has been utilized, or the like.

In an embodiment, the computing cloud and at least the control computer may be operated in a first operating mode, in which there is a data connection between the first and the second data processing means and the applicator is at least controlled via the computing cloud and the control computer, or in a second operating mode, in which a data connection between the first and the second data processing means is interrupted, at least the controlling data set is cached at the control computer and the applicator is controlled on basis of the cached control data set. Thus, there is no need to provide a permanent data connection between the computing cloud and the manufacturing site.

A second aspect of the present invention provides a computing cloud for manufacturing an insulated member. The computing cloud comprises a first data interface adapted to at least obtain data associated with the insulated member, provided by at least one user interface of a manufacturing planning site. The computing cloud further comprises a first data processing unit adapted to process the obtained data associated with the insulated member to determine geometric data of a raw part to be applied with an insulation material, to determine a movement data associated with the application of the insulation material onto at least a section of the raw part and to determine an amount of the insulation material to be applied onto the application section, and adapted to generate a control data set. The computing cloud further comprises a second data interface adapted to at least provide the control data set to a manufacturing-site applicator adapted to process the control data set to apply the insulation material onto the application section. The computing cloud may be adapted to carry out the in particular cloud-based method steps described above. As used herein, the computing cloud may in particular be a computer system that provides shared configurable computer system resources and services that can be provided via a network communication system.

Thus, an efficient and effective means for manufacturing an insulated member may be provided. In particular, the method may be performed by computing resources by the computing cloud. Further, as the method may be performed cloud-based it may be thus be provided scalable and particularly flexible. All steps of manufacturing may be carried out essentially simultaneously via the computing cloud. Hence, an automatic, cloud-based manufacturing system may be provided.

In an embodiment, the first and/or the second data interface may be adapted to communicate via a data network system, such as the Internet.

In an embodiment, the computing cloud may comprise an artificial-intelligence-module, AI-module, implemented within the computing cloud or connectable to the same. The AI-module may comprise a classifier or the like, adapted to process a process data set provided by the manufacturing site control computer. The AI-module may be adapted to analyze the process data with respect to application quality of the applied insulation material, to automatically generate application reports etc. It may further be adapted to provide corresponding data to the planning site.

A third aspect of the present invention provides a manufacturing-site applicator for manufacturing the product. In some embodiments, the product may be an insulated member. The manufacturing-site applicator may comprise a control computer, e.g. the above edge computing device, having a third data interface adapted to at least obtain a control data set by a computing cloud, and a second data processing unit adapted to process the obtained control data set comprising at least geometric data of a raw part to be applied with a further material, e.g. an insulation material, movement data associated with the application of the further material onto at least a section of the raw part and amount data of the further material to be applied onto the application section. Further, the manufacturing-site applicator may comprise an application robot adapted to be controlled by the control computer on basis of the control data set and to apply the further material onto the application section. It is noted that the control computer may be provided as an embedded system embedded in the application robot. It may process embedded software, such as a firmware, adapted to process the obtained control data set.

Thus, an efficient and effective means for manufacturing an insulated member may be provided. In particular, the method may be performed by computing resources of the computing cloud. Further, as the method may be performed cloud-based it may thus be provided scalable and particularly flexible. All steps of manufacturing may be carried out essentially simultaneously via the computing cloud. Hence, an automatic, cloud-based manufacturing system may be provided.

In an embodiment, the raw part may be provided as a construction panel. For example, the raw part may comprise flat surfaces, grooves, cavities, etc. It may be made from wood, metal, plastics, or the like.

According to an embodiment, the applicator may comprise an insulation material supply device, which may be connectable or connected to the application robot.

In a further embodiment, the insulation material supply device may be provided as a foam reactor, proportioner or the like, which may comprise a pump, a heating device etc.

According to an embodiment, the control computer may have a further data interface to the insulation material supply device which may be connected or connectable to the applicator. It may further be controllable or controlled on basis of the control data set provided by the computing cloud.

In an embodiment, the computing cloud may be adapted to dynamically change the relative movement between the applicator and the raw part on basis of a process data set obtained from the manufacturing site.

A fourth aspect of the present invention provides a system for manufacturing an insulated member. The system comprises a computing cloud according to the second aspect and a manufacturing-site applicator according to the third aspect, which is at least temporarily connectable to the computing cloud.

In an embodiment, the system may further comprise one or more user interfaces associated with a planning site at least temporarily connectable to the computing cloud. The planning site and/or the user interfaces may be associated with graphical display means and/or data manipulation means associated with CAD design, plant management, robot operation and/or administration tasks.

A fifth aspect of the present invention provides computer program element for manufacturing an insulated construction member, the program, when being executed by a processing unit, is adapted for carrying out the method in particular according to the first aspect. The computer program element, or parts of the same, may be adapted to be processed particularly by a computing cloud according to the second aspect and/or by a manufacturing-site applicator according to the third aspect.

A further aspect of the present invention provides a computer-implemented method of providing production material. The method of providing production material comprises the steps, which not necessarily need to be performed in the order listed, of:
Obtaining, from a manufacturing site, data associated with a manufacturing-site material container.
Processing, by a data processing unit, the obtained data associated with the manufacturing-site material container to determine at least a quantity of material available in the manufacturing-site material container.
Providing, to the manufacturing site, data at least adapted to trigger replenishment instructions dependent from said determination of the quantity of material available in the manufacturing-site material container.

The present method may be implemented in computer program instructions, e.g. provided as one or more computer program products, and may be performed, for example, by one or more computing devices, in particular by one or more computing devices, and more particularly by one or more computing devices of a distributed computer system. Preferably, such a distributed computer system may comprise one or more computing devices, and in particular one or more of a computing cloud, a client-server system or the like, and a manufacturing site computing device, such as an edge computing device, or the like. In some embodiments, it may be contemplated that individual computation steps can be processed on different data processing units. This means that the distributed computer system may be implemented centrally via cloud computing or remotely via edge computing, or by a combination of cloud computing and edge computing. As used herein, the computing devices may be distributed to several sites remote to each other. For example, there may be a designing site, plant managing site, applicator and/or robot operating site and/or administration site, which in the following are collectively referred to as a planning site. Further, there may be a manufacturing site at which the physical manufacturing is performed and, at least in some embodiments, a computing cloud site which may also be referred to as a central site. It may be possible for one or more of the sites collectively referred to as the planning site to access or communicate with the central site.

In at least some embodiments, at the manufacturing site, a physical production or manufacturing system may be arranged, comprising one or more production or manufacturing means. One of these means of the system may be the manufacturing-site material container as described above. Further, for example, the system may comprise application means adapted to apply the production material hold by the manufacturing-site material container. The application means may also comprise, for example, a robot or the like. If the production material is to be applied as a foam or the like, the system, e.g. the application means or robot, may further comprise a spraying gun. In at least some embodiments, the manufacturing-site material container may be connected to a proportioner to convey the production material from the manufacturing-site material container to be applied, e.g. by use of the application means or robot. For example, the proportioner may comprise or may be formed by a pump or the like. Further, at the manufacturing site, the system may comprise an edge computing device adapted to control one or more means of the system, such as the manufacturing-site material container, the optional application means, the optional proportioner, etc. Preferably, the system, e.g. the edge computing device, may comprise a data interface and/or communication interface adapted to communicate electronically with one or more of the above sites, particularly the central site and/or the computing cloud, which, in turn, may be adapted to communicate with one or more of the above sites. At one or more of the above sites, there may also be provided one or more user interfaces adapted to input and/or output data. As used herein, a user interface may generally be adapted to provide, to a user, means for data manipulation, such as icons, buttons, selection fields, wherein manipulated data may be provided as a corresponding output signal. Further, as used herein, a user interface may generally be adapted to provide a graphical display of data provided to the user interface as an input signal generated by the computing cloud and/or the manufacturing site. The graphical display may comprise means for visualization of data, such as a progress bar etc., highlighting data, or the like.

As used herein, the term “remote” can be understood to mean that the manufacturing-site material container is at least separated from the computing means carrying out the present method by a data line or the like. In this case, the computing means may be an edge computing device located somewhere at or near the manufacturing site and connected to the manufacturing-site material container. In some embodiments, the term “remote” can be understood to mean that the manufacturing-site material container is located at a first site, preferably the above manufacturing site, while the computing means carrying out the present method is located at a different site, which different site may be located in another town, in another country, in another continent, etc. The different site may be, for example, the above central site if the method is carried out by a server or computing cloud. In some embodiments, however, the present method may be carried out at the manufacturing site, e.g. by use of the edge computing device.

The data to be obtained may be obtained electronically via a data line, a network, such as the internet etc., or the like.

The term “manufacturing-site material container”, as used herein, may be interpreted broadly. For example, it may be any type of container or the like, adapted to hold production material therein at least temporarily and to make it available one by one or at once for dispensing or taking out. One or more manufacturing-site material containers may be arranged on a pallet or the like. In some embodiments, the manufacturing-site material container may be provided, for example, as a barrel. Such a manufacturing-site material container may be replaced in a physical process after it has been emptied or when empty. By way of example, in case of a barrel, the physical process of replacement may comprise unscrewing lines and/or cables from the barrel, bringing a new barrel or several new barrels on a pallet, and connecting the one or more barrels to the system. Further, the manufacturing-site material container may also be reusable by refilling. The manufacturing-site material container used may be specified in a database, which database may be accessible by at least the computing device carrying out the present method. Such an information may comprise an identifier assigned to a specific user or customer that purchased the manufacturing-site material container, so that a specific manufacturing-site material container may be assigned to a specific customer. Further, such a specification of the manufacturing-site material container may comprise one or more of a volume, weight etc. of the manufacturing-site material container, e.g. the container, as a whole, or may refer only to the production material contained therein of only the production material. A volume may be expressed in e.g. liters (l) or cubic decimeters, cubic meters etc., and a weight may be expressed in kilograms (kg). It is also possible to specify a relative size, i.e. the volume and/or weight, in percent, where a full container may be specified as 100%, a three-quarter full container as 75%, a half-full container as 50%, a quarter full container as 25%. It should be noted that with a percentage, depending on a desired resolution, in principle any non-integer or integer value between 0% and 100% may be used. Such a manufacturing-site material container may be assigned to a specific customer which may be a customer who may be any user of the production material, particularly within in the database. In some embodiments, the material taken from the manufacturing-site material container during production may be captured, so that the value may change from 100% to 99%, 98%, . . . , 60%, . . . 50%, . . . , 25%, . . . , 10% to 0%, wherein the steps of change may depend on the desired resolution. Preferably, the computing device is configured to know, e.g. by capturing or obtaining respective data and/or information, an actual quantity of the available and/or remaining material within the manufacturing-site material container, such as the actual volume or weight.

The production material may be any type of material, such as concrete, polyamide, polyurethane, or the like. In at least some embodiments, the production material to be provided may be a foamable material, such as polyurethane, and may, for example, be provided in a barrel. In some embodiments, the production material may be composed of at least two different materials during application, wherein a first material may be hold in a first manufacturing-site material container and a second material may be hold in a second manufacturing-site material container. In this case, more than one manufacturing-site material container may be monitored and/or controlled according to the present method.

The data to be provided may be provided electronically via a data line, a network, such as the internet etc., or the like. By these data, for example, a data output may be triggered or generated. The data output may comprise one or more of a graphical output, a sound output, or the like. This is preferably output via a user interface, which may include a display, a loudspeaker or the like. Preferably, the data may comprise a message or the like, which may be regarded as an example of a trigger. The replenishment instructions may comprise a request for replenishment of production material to a user, preferably in form of the above data output. In some embodiments, it may be requested a confirmation of receipt of the replenishment instructions and/or the execution of the replenishment, which may then be provided from the manufacturing site as feedback data. There may be one or more thresholds set for triggering replenishment of material. If the material quantity falls to such a threshold, the material replenishment may then be triggered. By way of example, such a threshold may be set to a remaining weight of x kg, a remaining volume of x l, and/or to a remaining weight or volume of x %.

As used herein, the term “replenishment” may be interpreted broadly, namely as refilling material without changing the manufacturing-site material container itself or as changing a container with its content, or the like. The term “replenishment instructions” may comprise, for example, a request, an alarm, which may also be understood synonymously.

The method may be used in a wide variety of manufacturing processes of a wide variety of industries, such as construction, wind turbines, etc. Some embodiments may be directed to manufacturing of an insulated member, used e.g. in numerous industries, such as construction industry, automotive industry, packaging industry etc. By way of example, such an insulated member may be used as an interior trim, as an exterior wall cladding, as a construction member, as packaging material, or the like, usable in a wide range of industries.

The present method may provide improved, efficient and effective means for providing production material. In particular, remote replenishment of the material can be initiated, monitored and/or controlled. Further, the material flow and/or material purchase may be monitored and/or controlled remotely.

According to an embodiment, the method may further comprise processing the obtained data associated with the remote manufacturing-site material container to determine whether one or more further scheduled jobs, i.e. further jobs which are already scheduled, is at least likely to be executable with the available quantity of the material and triggering replenishment instructions if the available quantity of the material is at least likely to be insufficient for executing the further scheduled jobs.

For example, one or more jobs, in particular manufacturing jobs for which the production material is to be used, to be executed at the manufacturing site may be queued, for example, at the central site, e.g. the computing cloud, at the planning site and/or at the manufacturing site, e.g. the edge computing device. These jobs may be input via e.g. a user interface, which may be provided at the manufacturing site or, preferably, at a job planning site, which may be located remotely from the manufacturing site and/or the central site, e.g. the computing cloud. These jobs may comprise information about a quantity of production material expected to be needed to execute these jobs, or that information may be derivable from these jobs by calculation, estimation etc. For example, this information may be already known from a product specification or may be obtained by processing a control data set, which may be based on geometric data of a product to be produced or manufactured and which may be obtained from, for example, via one or more user interfaces associated with the planning site. By way of example, if the material available in the manufacturing-site material container reaches the above threshold, e.g. 5% of the initial total volume or total weight, and the next job of the queue is expected to need more material, e.g. 6%, . . . , 10%, 20%, etc. material, possibly plus a security surcharge, the replenishment instructions may be triggered.

Thus, it can be assured that the job can be executed before the start of the execution of a job. This may reduce or avoid product waste.

In an embodiment, the method may further comprise triggering, simultaneously or time-delayed, a stop of at least material feed from the manufacturing-site material container when triggering the replenishment instructions.

For example, the stop of at least material feed, material application, or the like may be triggered or initiated after the previous job has been completed. The trigger, e.g. a signal, message, data field etc., may be contained in the data provided to the manufacturing site as explained above.

Thus, it can be assured that the job can be executed before the start of the execution of a job. This may reduce or avoid product waste.

According to an embodiment, the method may further comprise obtaining, from the manufacturing site, data associated with a status of replenishment.

These data may be obtained electronically via a data line, a network, such as the internet etc., or the like. The data may be generated automatically by detection means, such as a filling or level sensor, a flow sensor, an optical detection means etc., or may be triggered manually by an operator, after replenishment of the material, the container, or the like. For the latter, for example, a prompt may appear along with or after the replenishment instructions, which prompt may be confirmed manually when the replenishment has been completed.

Thus, information about the quantity of product material available at the manufacturing site can be obtained from any other of the above sites. In particular, any other of the above sites may be obtain that information from e.g. the central site, and particularly from the computing cloud.

In an embodiment, the data associated with a status of replenishment may comprise information whether the material has already been replenished and/or whether the manufacturing-site material container is operational. Further, in some embodiments, these data may comprise information about which exact manufacturing-site container is used. For this purpose, its identifier, e.g. an ID number etc., may be obtained, e.g. captured and/or processed.

For example, the data associated with a status of replenishment may be generated automatically by e.g. detecting the replenishment, or may be generated in response to a manual user input of an operator.

Thus, information about the quantity of product material available at the manufacturing site can be obtained from any other of the above sites. In particular, any other of the above sites may be obtain that information from e.g. the central site, and particularly from the computing cloud.

According to an embodiment, the data associated with a status of replenishment may comprise a, preferably computer-readable, material identifier of the replenished material, the material identifier at least associated with a type of the replenished material. By way of example, the material identifier may be represented or formed by an ID number or the like.

For example, the material identifier may be adapted to be read and/or detected electronically. For this purpose, an RFID reader, RF module, e.g. an NFC module, an optical scanner, a camera, or the like, may be used. In some embodiments, the material identifier may comprise an RFID tag, barcode, QR code, or the like. The material identifier may be arranged on the manufacturing-site material container, pallet, or the like. By way of example, the material identifier may be represented or formed by an ID number, serial number, or the like.

Thus, initiating, monitoring and/or controlling of remote replenishment of the material may be further improved.

In an embodiment, the method may further comprise comparing the captured material identifier uniquely assigned to one specific manufacturing-site material container with a previously recorded identifier uniquely assigned to the manufacturing-site material container, and using the data associated with a status of replenishment to (i) update material quantity information assigned to the manufacturing-site if the identifiers match, or (ii) trigger an alarm signal if the identifiers differ from each other.

For example, the identifier uniquely assigned to the manufacturing-site material container may be obtained from the above database or any other suitable database. The database may be provided in particular at the central site, e.g. by the above computing cloud or server. There, for each user of the material, i.e. for each customer, a specification of one more containers for materials that has been delivered to the respective customer may be provided. Accordingly, the update of material quantity information may be assigned to the respective customer, particularly within the database. For example, the update material quantity information assigned to the manufacturing-site material container may be updated from a previous value to a new, actual value, the new or actual value representing the now available quantity of product material. Alternatively, the alarm signal, which may be any type of signal adapted to cause a graphical output and/or audio output or the like, may be triggered if the captured material identifier differs from the known, i.e. previously recorded, identifier assigned to the manufacturing-site material container and/or customer.

Thus, information about the quantity of product material available at the manufacturing site can be obtained from any other of the above sites. In particular, any other of the above sites may be obtain that information from e.g. the central site, and particularly from the computing cloud.

According to an embodiment, the method may further comprise monitoring and/or tracking a quantity of the material taken from the manufacturing-site material container.

For example, the monitoring and/or tracking may be carried out at the central site, and particularly by the computing cloud, and/or by the above edge computing device. In some embodiments, data, e.g. variables, to be monitored and/or tracked may comprise one or more of: consumption/usage, e.g. measured in kg, yield, e.g. measured in m²/kg, coverage, e.g. measured in m², etc. At least some of these data may be monitored and/or tracked per customer, per individual job, e.g. per product to be produced or manufactured, per collection of jobs, e.g. per house in case of a construction job, per manufacturing site, per material type, per manufacturing-site material container, e.g. barrel or the like, installed. These data may comprise an estimated value and/or a determined value. By way of example, at e.g. the above planning site, these data may be estimated and/or determined on the basis of CAD data of the respective product uploaded by the customer. Then, the planning site, central site and/or the edge computing device, monitors and/or tracks the data obtained from the manufacturing site and updates values based on the actual and/or determined data in e.g. the database. In more detail, at e.g. the above planning site, CAD data of the respective product may be processed by a data processing unit. From that, it may be derived e.g. a volume of the production material to be applied to a raw part. Thereby, a required thickness of the production material may be derived by a desired insulation value, which may be referred to as R-value indicating how well the insulated member resists conductive flow of heat. A density of the production material may be known from the respective material specification. On this basis, all relevant data may be determined by calculation.

Thus, monitoring and/or tracking of the use of production material, of customer behavior etc. may be further improved.

In an embodiment, the method may further comprise predicting the quantity of material expected to be required over a specified or determinable period of time, depending on at least one of: (i) material usage information of one or more further scheduled jobs, (ii) material usage information of past usage of a present user, and/or (iii) material usage information of past usage of at least one reference user.

For example, this prediction may be based on calculation and/or estimation. In some embodiments, one or more machine learning algorithms may be used for this purpose, which algorithm may be available as software libraries and which may adapted by training the algorithm by a suitable set of training data. For each scheduled job, at least the approximate value may be known, namely by processing the product design data, e.g. the CAD data, as described above. Further, the quantity of production material available at the manufacturing site may be known, namely by monitoring and/or tracking the quantity of production material previously delivered to the manufacturing site and/or the quantity used so far. By way of example, it may be known that a specific customer has only a quantity x of product material, e.g. a number x of containers, left. From the prediction, it may be derived that the number of jobs queued may require a quantity y of product material, wherein y may have a value different to x. Further, the period of time may be given in any time unit suitable for the specific application, such as seconds (s), minutes (min), hours (h), days (d), weeks (wk), etc. Thereby, the reference user may be a user located in a comparable region, manufactures comparable products, etc., and therefore uses a similar quantity of material.

Thus, it may be determined in advance whether a material purchase order must be triggered and/or when a material purchase order must be triggered and/or what quantity of material must be ordered.

According to an embodiment, the method may further comprise obtaining data associated with a manufacturing-site stock quantity of material available for replenishment.

For example, the stock quantity of material may be hold in a material stock, such as a warehouse, a depot, or the like, from which the product material is taken for actual processing, e.g. packed in the manufacturing-site material container. However, the material stock does not necessarily have to be a separate room or building, but may simply be a place where further production material can be stored in addition to the manufacturing-site material container.

Thus, it may be determined in advance whether a material purchase order must be triggered and/or when a material purchase order must be triggered and/or what quantity of material must be ordered.

In an embodiment, the method may further comprise triggering an order of an additional stock quantity of material dependent from the obtained data associated with the available stock quantity of material.

The additional stock quantity may be provided to refill or replace the manufacturing-site material container. The trigger may cause a suitable message or the like at a suitable site, e.g. one or more of the above sites, such as the plant managing site, from which the manufacturing process may be managed, monitored, controlled etc.

Thus, material purchase order may be managed or controlled with an improved degree of automation.

A further aspect of the invention provides a computer-implemented method of providing production material, comprising:
Providing, to a processing unit, data associated with a manufacturing-site material container.
Obtaining, in response to the provided data associated with a manufacturing-site material container, data at least adapted to trigger replenishment instructions dependent from a determination of a quantity of material available in the manufacturing-site material container.

This method may be carried out by a computing device, which may particularly be located at the manufacturing site. This computing device may be, for example, the above manufacturing site computing device, and more particularly the edge computing device.

According to an embodiment, the method may further comprise capturing data associated with a replenishment of the manufacturing-site material container, the captured data at least associated with a material identifier at least indicating a type of the replenished material, and providing the captured data.

For example, the material identifier may be a computer-readable means, such as a barcode, QR code, an RFID tag, or the like. It may be provided on the manufacturing-site material container, such as a container, barrel etc., or on a pallet, or on both. At the manufacturing site, there may be one or more means adapted to capture and/or detect the material identifier, such as an optical detecting means, e.g. a camera, a barcode scanner, a QR code scanner, a RFID reader, etc.

Thus, automation of the manufacturing process may be further improved. In particular, material monitoring and/or tracking may be further improved.

A further aspect of the invention provides a computing device, comprising means for carrying out the method of the above aspects.

For example, one or more computing devices may be provided, wherein, in some embodiments, the computing devices may be provided at different sites. By way of example, a first computing device may be provided at the central site, e.g. as the above computing cloud. And a second computing device may be provided at the manufacturing site, e.g. as the above edge computing device.

In some embodiments, the computing cloud may comprise a first data interface adapted to at least obtain data associated with the product, provided by at least one user interface of the manufacturing planning site. In some embodiments, the product may be an insulated member. The computing cloud further comprises a first data processing unit adapted to process the obtained data associated with the product to determine geometric data of e.g. a raw part to be applied with a further material, e.g. an insulation material, to determine a movement data associated with the application of the further material onto at least a section of the raw part and to determine an amount of the further material to be applied onto the application section, and adapted to generate a control data set. The computing cloud may further comprise a second data interface adapted to at least provide the control data set to a manufacturing-site applicator adapted to process the control data set to apply the insulation material onto the application section. The computing cloud may be adapted to carry out the in particular cloud-based method steps described above. As used herein, the computing cloud may in particular be a computer system that provides shared configurable computer system resources and services that can be provided via a network communication system.

A further aspect of the invention provides a computer program product comprising instructions, which, when the program is executed by a computing device, cause the computing device to carry out the method according to any embodiment of the above aspects. The computing device used may be the one or more computing devices of the above aspects, which may also be connected to each other.

A further aspect of the invention provides a manufacturing-site applicator for manufacturing the product. In some embodiments, the product may be an insulated member. The manufacturing-site applicator may comprise a control computer, e.g. the above edge computing device, having a third data interface adapted to at least obtain a control data set by a computing cloud, and a second data processing unit adapted to process the obtained control data set comprising at least geometric data of a raw part to be applied with a further material, e.g. an insulation material, movement data associated with the application of the further material onto at least a section of the raw part and amount data of the further material to be applied onto the application section. Further, the manufacturing-site applicator may comprise an application robot adapted to be controlled by the control computer on basis of the control data set and to apply the further material onto the application section. It is noted that the control computer may be provided as an embedded system embedded in the application robot. It may process embedded software, such as a firmware, adapted to process the obtained control data set.

A further aspect of the invention provides a system for manufacturing a product. The system may comprise a computing cloud according to the above aspects and a manufacturing-site applicator according to the above aspects, which is at least temporarily connectable to the computing cloud.

These and other aspects of the present invention will become apparent from and elucidated with reference to the embodiments described hereinafter.

Exemplary embodiments of the invention will be described in the following with reference to the following figures.

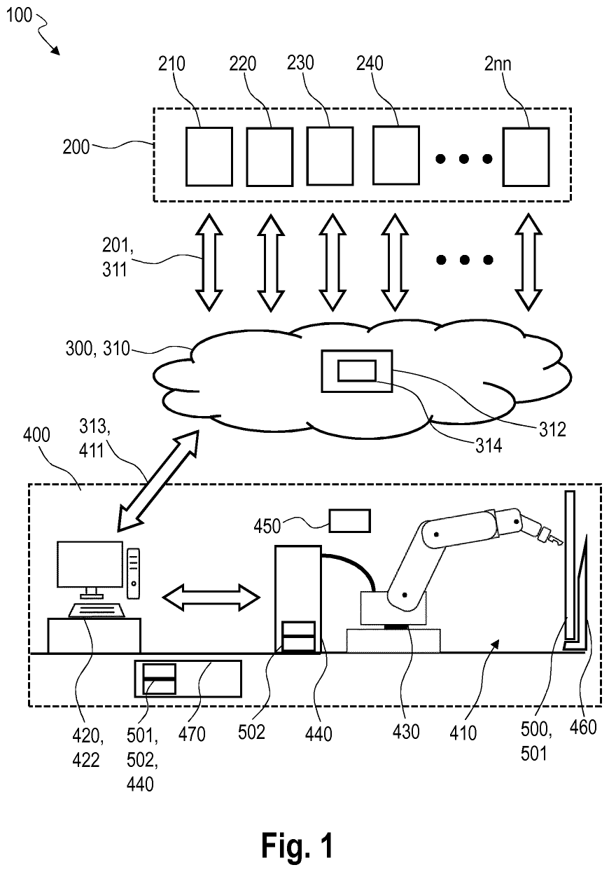

FIG. 1 shows a schematic block diagram of a system for manufacturing a product, according to an embodiment of the invention.

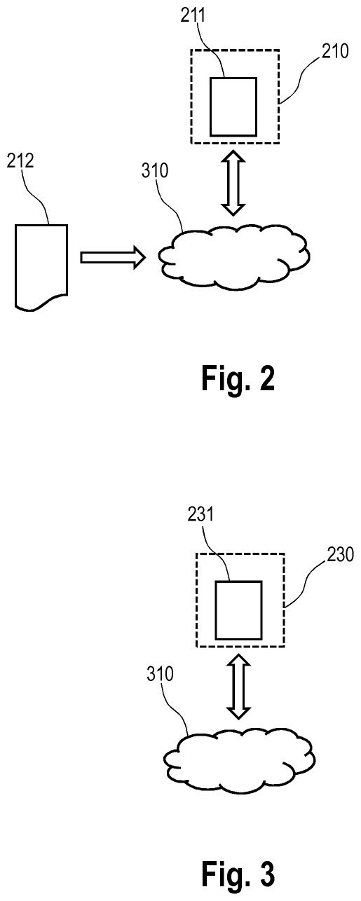

FIG. 2 shows a schematic block diagram of a CAD design function module, which may comprise a processing unit, a computer device, and/or computer program instructions that perform a technical function when processed by a processor of a computer device, associated with a planning site of a system for manufacturing a product, according to an embodiment of the invention.

FIG. 3 shows a schematic block diagram of a robot operation function module, which may comprise a processing unit, a computer device, and/or computer program instructions that perform a technical function when processed by a processor of a computer device, associated with a planning site of a system for manufacturing a product, according to an embodiment of the invention.

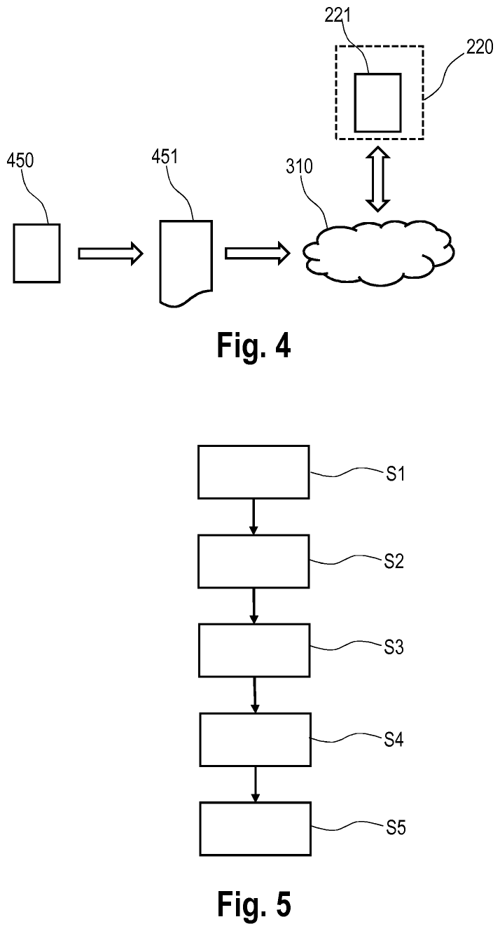

FIG. 4 shows a schematic block diagram of a plant manager function module, which may comprise a processing unit, a computer device, and/or computer program instructions that perform a technical function when processed by a processor of a computer device, associated with a planning site of a system for manufacturing an insulated member, according to an embodiment of the invention.

FIG. 5 shows a flow chart of a method for manufacturing a product, according to an embodiment of the invention.

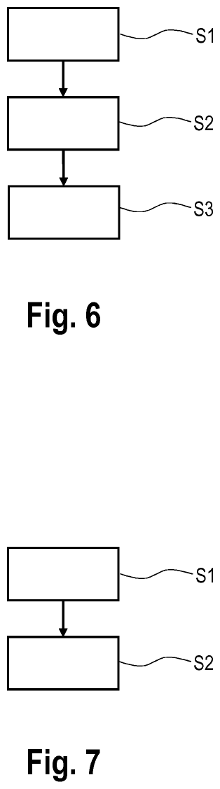

FIG. 6 shows a flow chart of a method for manufacturing a product, according to an embodiment of the invention.

FIG. 7 shows a flow chart of a method for manufacturing a product, according to an embodiment of the invention.

The figures are merely schematic representations and serve only to illustrate the invention. Identical or equivalent elements are consistently provided with the same reference signs.

FIG. 1 shows in a schematic block diagram a system 100 for manufacturing a specific product 500. Although system 100 is described below in relation to an exemplary product designed as an insulated member (as an example of product 500), the system 100 can of course also be used to manufacture other products. Exemplary applications of system 100 may be 3D printing, various products in the automotive industry, etc.

Accordingly, in some embodiments, product 500 may be an insulated member, such as a construction panel used for panelized buildings, in the prefabricated building industry, or the like. In some embodiments, product 500 may be manufactured from one or more production materials, such as a raw part 501 having at least one material application section, e.g. a surface, a cavity or the like, a further material 502 applied thereon, etc. If the product 500 to be manufactured is an insulated member, the further material 502 may be an insulation material. In some embodiments, the further material 502 may be a foamable insulation material, such as polyurethane or the like.

Still referring to FIG. 1, system 100 can be divided into different sites, namely at least into one or more planning sites 200, a central site 300, which may be a computing cloud site, and a manufacturing site 400, where the actual manufacturing of product 500 may be carried out. In FIG. 1, the different sites are indicated by dashed lines or a cloud representation, respectively. The sites 200, 300, 400 may be arranged remote from each other and may be connectable or connected via a data line or a network communication system, such as the Internet. It is noted that the central site 300 may serve as a kind of central data exchange between the sites 200 and 400.

System 100 comprises, at the planning site 200, one or more function modules 210, 220, 230, 240, 2nn which may be provided by one or more computing devices, which may also be arranged remote from each other. For example, the function modules 210, 220, 230, 240, 2nn may comprise a processing unit, a computer device, and/or computer program instructions that perform a technical function when processed by a processor of a computer device. The function modules 210, 220, 230, 240 may be associated with CAD design (e.g. function module 210), plant management (e.g. function module 220), robot operation (e.g. function module 230) and/or administration tasks (e.g. function module 240). The function modules 210, 220, 230, 24 may be associated with graphical display means and/or data manipulation means associated with corresponding control means adapted to be data connected to the computing cloud site 300, in particular the computing cloud 310. The CAD design function module 210 is, for example, adapted to provide means for creating geometric data associated with the product 500. In some embodiments, these geometric data may be related to e.g. the raw part 501. The plant manager function module 220 is, for example, adapted to provide a job planer or job scheduler, respectively. Further, the plant manager function module 220 is adapted to process data associated with utilization of the manufacturing site 400. The robot operation function module 230 is, for example, adapted to execute the jobs of the plant manager function module 220 by use of the manufacturing site 400. It is noted that the function modules 210, 220, 230, 240, 2nn are adapted to use computer system resources and/or services of the computing cloud site 300. It may also be contemplated that, in some embodiments, the function modules 210, 230, 240, 2nn are provided by and/or processed on a local computer system. Accordingly, the planning site comprises a data interface 201 connectable or connected to the cloud computing site 300.

The system 100 comprises, at the computing cloud site 300, a computing cloud 310 which is adapted to provide computer system resources and services via a network communication system, such as the Internet. Accordingly, the computing cloud 310 comprises first data processing means 311, which comprises one or more processors, data storage etc.

The computing cloud 310 comprises a first data interface 311, via which the computing cloud is connectable or connected to the planning site 200. Accordingly, the computing cloud 310 is adapted to at least obtain data associated with the product 500, which data is at least partly provided by the planning site 200. These data may be provided via the data interfaces 201, 311 by the e.g. function modules 210, 220, 230, 240, 2nn of the planning site 200. The computing cloud 310 further comprises a first data processing unit 312 adapted to process the obtained data associated with the product 500 to determine geometric data of the product, such as a raw part 501 to be applied with an insulation material 502. The geometric data may be generated by use of the CAD design function module 210. Further, the first data processing unit 311 is adapted to determine a movement data associated with manufacturing the product 500, such as a movement associated with the application of the insulation material 502 onto at least a section of the raw part 501, and to determine an amount or quantity of the production material, such as an amount or quantity of the insulation material 502 to be applied onto the application section, and adapted to generate a control data set. The computing cloud 310 further comprises a second data interface 313 adapted to at least provide the control data set to the manufacturing site 400 which is adapted to process the control data set to apply the insulation material 502 onto the application section of the raw part 501. The computing cloud 310 further comprises an artificial-intelligence module 314, comprising e.g. machine learning means, an artificial neural network, or the like.

The system 100 comprises, at the manufacturing site 400, an applicator 410, and in particular a control computer 420 having a third data interface 421 adapted to at least obtain the control data set provided by the computing cloud 310, and a second data processing unit 422 adapted to process the obtained control data set comprising at least the geometric data of the product 500, such as geometric data of the raw part 501 to be applied with the insulation material 502, the movement data associated with the application of the insulation material 502 onto the application section of the raw part 501 and data associated with the quantity or amount data of production material, such as the insulation material 502 to be applied onto the application section. Further, the manufacturing site 400 comprises an application robot 430 adapted to be controlled by the control computer 420 on basis of the control data set. If the product 500 is the insulating member, the application robot 430 may be adapted to apply the insulation material 502 onto the application section of the raw part 501. In some embodiments, the application robot 430 is an industrial robot having six or more degrees of freedom, wherein other type of robots are conceivable. In addition, the application robot 430 is adapted to handle the production material, such as moving the raw part 501 and/or moving, applying etc. the insulation material 502 by grasping, spraying, pouring, or the like. For this purpose, the applicator 410, and in particular the application robot 430 comprises, for example, a tool, such as a spraying gun, a spraying head or the like. Further, the manufacturing site 400 comprises an insulation material supply device or, respectively, a manufacturing-site material container 440, adapted to provide, and in particular hold, feed and/or convey, the material, such as the raw part 501, the insulation material 502, or the like, to the application robot 430. In some embodiments, the manufacturing-site material container 440 itself or means interacting with it may further comprise a foam reactor, proportioner, etc., comprising a pump etc. Further, the manufacturing-site material container 440 may comprise one or more containers of production material, one or more pallets, or the like. The manufacturing site 400 further comprises a manufacturing site process monitoring means 450, which may comprise one or more detection or monitoring means, such as a camera, a barcode scanner, a RFID reader, a flow sensor, a level sensor, or the like. The manufacturing site process monitoring means 450 is connected to the control computer 420 to generate a process data set and/or data associated with the manufacturing-site material container 440. In some embodiments, the data comprise e.g. process data associated with the production material already used, e.g. the insulation material 502 already applied to the application section of the raw part 501, or the like. Further, the manufacturing site process monitoring means 450 and/or the control computer 420 is adapted to provide the process data set 451 (see FIG. 4) to the computing cloud 310.

Further, in some embodiments, the manufacturing site 400 comprises a holding device 460 adapted to hold, feed and/or move e.g. the raw part 501. The holding device 460 is connectable or connected to the control computer 420 to be controlled based on the control data set provided by the computing cloud 310. It is noted that the raw part 501 and the application robot 430 may be moved relative to each other by either only controlling the application robot 430 to be moved with respect to raw part 501, or only controlling the holding device 460 to be moved with respect to the application robot 430, or by both controlling the application robot 430 and the holding device 460 to be moved with respect to each other.

Still referring to FIG. 1, the manufacturing site 400 comprises a material stock 470. The material stock 470 is adapted to store a stock quantity of the production material as used in or as the manufacturing-site material container 440. For example, in the material stock 470, one or more of the manufacturing-site material containers 440, e.g. barrels, containing the production material may be stored. The material stock 470 may comprise means, such as a data interface, a communication interface, detection means etc. to exchange data with any one of the other sites, and in particular with the planning site 200 and/or the central site 300.

FIG. 2 shows a schematic block diagram of the planning site 200. The CAD design function module 210 provides a graphical CAD design user interface 211 associated with the computing cloud 310. The CAD design user interface 211 is adapted to allow a user to load a CAD file 212 (e.g. a .dwg, .dxf, .ehx file) to be displayed and cached or stored to the computing cloud 310. It is noted that the CAD design function module 210 uses computer resources provided by the computing cloud 310. For example, in this way, geometric data of the product, e.g. a stack of raw parts 501 or a single raw part 501, may be loaded into the in the CAD design function module 210. By way of example, geometric data (e.g. names) and properties are automatically recognised by the software CAD design function module 210, in particular by use of computer resources of the computing cloud 310. In some embodiments, the application section of the raw part 501, e.g. cavities, are automatically preselected for a robotic path. Geometric data of the raw part 501 not fitting to selected parameters, are graphically highlighted. CAD design function module 210 compares geometric dimensions of the raw part 501 to a spacing, padding etc. of the robotic path and graphically highlights the same if the former is too small for the latter. In at least some embodiments, via the CAD design user interface 211, manipulating of the geometric data is possible. The CAD design user interface 211 is adapted to generate an output signal comprising the manipulated geometric data.

Further, the CAD design function module 210 is adapted to, via the graphical CAD design user interface 211 associated with the computing cloud 310, input further product-relating information, such as a desired insulation value, e.g. a so-called R-value, of the finalized insulated member 500. In some embodiments, on basis of the input desired insulation value, the CAD design function module 210, using computer resources of the computing cloud 310, determines a required thickness of one or more layers of the insulation material 502 and an overshoot of the insulation material 502 with respect to the geometric data obtained from the CAD file 212. The CAD design user interface 211 is adapted to generate an output signal comprising the input desired insulation value.

The CAD design function module 210 further allows, via the graphical CAD design user interface 211 associated with the computing cloud 310, to input a general application direction for applying the insulation material 502 to the application section of the raw part 501, such as vertical and horizontal. The CAD design function module 210 may be adapted to automatically apply the selected application direction to all raw parts in the stack. Further, the CAD design function module 210 allows, via the graphical CAD design user interface 211 associated with the computing cloud 310, to adjust the application parameters used for application the insulation material 502 to the application section of the raw part 501, such as speed, padding, spacing, direction to be performed by the application robot 430 and/or the material supply device 440.

In some embodiments, the CAD design function module 210 allows, via the graphical CAD design user interface 211 associated with the computing cloud 310, to select a “picture frame” option. In this process, the application robot 430 starts with applying the insulation material 502 to all four edges of the raw part 501, in particular of a cavity of the same, and only then applies the insulation material 502 in a normal pattern, in which normal pattern the insulation material 502 is applied to a surface enclosed by the four edges.

On basis of some or all of the above data, the CAD design function module 210 allows to generate the control data set, which is at least temporarily stored to the computing cloud 310.

FIG. 3 shows a further schematic block diagram of the planning site 200. The robot operation function module 230 provides a graphical robot operation user interface 231 associated with the computing cloud 310. In the robot operation user interface 231 one or more control data sets provided by the the CAD design function module 210 are queued and displayed. In other words, all of these jobs to be done are graphically represented to be listed. The graphical robot operation user interface 231 allows the control data sets to be manipulated, so as to be rearranged, deleted etc. Further, the robot operation user interface 231 allows to display a predicted, estimated or determined job duration time, an estimated finish time, a predicted, estimated or determined amount of foam per job to be displayed, wherein the underlying data is obtained from the computing cloud 310, which provides the computer resources and services required. In other words, the computing cloud 310 summarizes this information to allow the graphical robot operation user interface 231 displaying when most likely the queued jobs will be finished and which quantity or amount of the product material, e.g. the insulation material 501, will be required.

Further, the robot operation user interface 231 allows an operator to select one or more of the jobs queued, which jobs are associated to one or more control data sets, and to provide, e.g. to load, the same to the control computer 420. Accordingly, the application robot 430 and/or the manufacturing-site material container 440 and/or the holding device 460 is then controlled to automatically process the computer instructions included in the control data set to manufacture the product 500, e.g. to apply the insulated material 502 onto the application section of the raw part 501. During the application, process monitoring means 450 monitors one or more parameters associated with the manufacturing of the product 500, such as the manufacturing-site material container 440, the application of the insulation material 502, etc. Further, the process monitoring means 450 provides a process data set 451 (see FIG. 4) including these data to the computing cloud 310.

FIG. 4 shows a further schematic block diagram of the planning site 200. For example, one of the function modules 210, 220, 230, 240, 2nn of the planning site 200 provides a graphical user interface 221 associated with the computing cloud 310. The graphical user interface 221 allows to display a number of parameters of the process monitoring means 450. Also a dynamically estimated, which is determined by the computing cloud 310, the quantity or amount of the production material, e.g. the insulation material 502, already used is displayed. It is noted that, on basis of these data, additional production material, e.g. the raw part 501 and/or the insulation material 502, may be purchased from a material supplier. In some embodiments, a material logistics system is automatically triggered to order a stock quantity of material on basis of the process data set 451.

Further, the graphical user interface 221 allows to display job reports, which are automatically generated by the computing cloud 310 and provided to the plant manager function module 220. For this purpose, the plant manager user interface 221 is adapted to process a signal generated by the computing cloud 310 and to display data contained in the signal in a graphically implemented progress bar or other suitable graphical means adapted to highlight relevant information. For example, the signal may be contained in the process data set 451.

FIG. 5 shows a flow chart of a method of manufacturing an insulated member 500. In a step S1, geometric data of at least a section of a raw part 501 having at least one application section to be applied with an insulation material 502 is provided to the computing cloud 310. In a step S2, on basis of the geometric data, the movement data for the relative movement between a manufacturing-site applicator 410, adapted to apply the insulation material 502 onto the application section of the raw part 501 is determined using the computing cloud 310. In a step S3, the amount of the insulation material 502 for applying onto the application section is determined using the computing cloud 310. In a step S4, the control data set at least comprising the movement data and the amount of insulation material 502 is determined using the computing cloud 310. In a step S5, the control data set to the manufacturing site control computer 420 is provided.

FIG. 6 shows a flow chart of a computer-implemented method of providing production material, according to an embodiment. In a step S1, data associated with the manufacturing-site material container 440 may be obtained from the manufacturing site 400. For example, these data may be represented or contained in the process data set 451 as described above. In a step S2, the obtained data, e.g. the process data set 451, associated with the manufacturing-site material container 440 is processed by a data processing unit to determine at least a quantity of material available in the manufacturing-site material container 440. The data processing unit used may be at least one of the first data processing unit 312 and the second data processing unit 422 as described above. In a step S3, data at least adapted to trigger replenishment instructions dependent from said determination of the quantity of material available in the manufacturing-site material container 440 is provided to the manufacturing site 400. These data may be provided via the third data interface 421, which may directly or indirectly connected to the manufacturing-site material container 440 and/or the control computer 420. For example, the replenishment instructions may comprise a message like: “Please replenish container no. xxxxxx by container yyyyyy”. Further, a user prompt may comprise: “Is container yyyyyy connected? Please confirm!”. Upon the confirmation the user prompt, respective data may be provided to the respective data processing unit.

Optionally, the method may further comprise a step of processing the obtained data associated with the manufacturing-site material container 440 to determine whether a further scheduled job is at least likely to be executable with the available quantity of the material and triggering replenishment instructions if the available quantity of the material is at least likely to be insufficient for executing the further scheduled job. As described above, one or more jobs may be scheduled in the manager function module 220, e.g. the job scheduler. The replenishment instructions may comprise one or more of a message, a user prompt or the like, directed to an operator at the manufacturing site 400, and may be processed by e.g. the control computer 420. Accordingly, these data may be provided via the via the third data interface 421. Further optionally, the method may further comprise a step of triggering, simultaneously or time-delayed, a stop of at least material feed out from the manufacturing-site material container 440 when triggering the replenishment instructions. This may be triggered via e.g. the third data interface 421. Optionally, the method may comprise a step of obtaining, from the manufacturing site 400, data associated with a status of replenishment. For example, these data may be represented or contained in the process data set 451 as described above, and may be generated automatically by the manufacturing site process monitoring means 450 as described above or may be generated upon a manual input by the operator, e.g. by confirming a user prompt.

Optionally, the data associated with a status of replenishment comprise information whether the material has already been replenished and/or whether the manufacturing-site material container 440 is operational. Optionally, the data associated with a status of replenishment comprise a material identifier of the replenished material, the material identifier at least associated with a type of the replenished material. Optionally, the method may comprise a step of comparing the material identifier with an identifier uniquely assigned to the manufacturing-site material container 440, and using the data associated with a status of replenishment to (i) update material quantity information assigned to the manufacturing-site material container 440 if the identifiers match, or (ii) trigger an alarm signal if the identifiers differ from each other. The alarm signal may be represented by a message etc. directed to e.g. the planning site 200. Optionally, the method may comprise a step of monitoring a quantity of the material taken from the manufacturing-site material container 440. Optionally, the method may comprise a step of predicting the quantity of material expected to be required over a specified or determinable period of time, depending on at least material usage information of one or more further scheduled jobs. Some or all of this information may be obtained from manager function module 220. Optionally, the method may comprise a step of obtaining data associated with a stock quantity of material available in the material stock 470 to be provided to the manufacturing-site material container 440 for replenishment. Optionally, the method may comprise a step of triggering an order of an additional stock quantity of material dependent from the obtained data associated with the available stock quantity of material. This trigger may be done via the third data interface 421, which may be also connected to the material stock 470.

FIG. 7 shows a flow chart of a computer-implemented method of providing production material, according to an embodiment. In a step S1, data associated with a manufacturing-site material container 440 is provided to a data processing unit. The data processing unit used may be at least one of the first data processing unit 312 and the second data processing unit 422 as described above. For example, these data may be represented or contained in the process data set 451 as described above, and may be generated automatically by the manufacturing site process monitoring means 450 as described above or may be generated upon a manual input by the operator, e.g. by confirming a user prompt. In a step S2, data at least adapted to trigger replenishment instructions dependent from a determination of a quantity of material available in the manufacturing-site material container 440 are obtained in response to the provided data associated with the manufacturing-site material container 440.

Optionally, the method may comprise a step of capturing data associated with replenishment material to be provided to the manufacturing-site material container 440, the captured data at least associated with a material identifier at least indicating a type of the replenished material and providing the captured data. These data may be captured and/or detected by use of e.g. the manufacturing site process monitoring means 450 or other suitable means.

Particular examples of embodiments described herein may include, but are not limited to, the following:

Example 1 may include a computer-implemented method of providing production material 500, 501, 502, comprising: obtaining, from the manufacturing site 400, data associated with the manufacturing-site material container 440, processing, by one or more of the data processing units 312, 422, the obtained data associated with the remote manufacturing-site material container 440 to determine at least a quantity of material available in the manufacturing-site material container 440, and providing, to the manufacturing site, data at least adapted to trigger replenishment instructions dependent from said determination of the quantity of material available in the manufacturing-site material container 440.

Example 2 may include the method according to example 1, further comprising: processing the obtained data associated with the manufacturing-site material container 440 to determine whether one or more further scheduled jobs is at least likely to be executable with the available quantity of the material, and triggering replenishment instructions if the available quantity of the material is at least likely to be insufficient for executing the further scheduled jobs.

Example 3 may include the method according to example 1 or 2, further comprising: triggering, simultaneously or time-delayed, a stop of at least material feed from the manufacturing-site material container 440 when triggering the replenishment instructions.

Example 4 may include the method according to any one of the preceding examples, further comprising: obtaining, from the manufacturing site 400, data associated with a status of replenishment.

Example 5 may include the method according to example 4, wherein the data associated with a status of replenishment comprise information whether the material has already been replenished and/or whether the remote manufacturing-site material container 440 is operational.

Example 6 may include the method according to example 4 or 5, wherein the data associated with a status of replenishment comprise a captured, particularly computer-readable, material identifier of the replenished material, the material identifier at least associated with a type of the replenished material.

Example 7 may include the method according to example 6, further comprising: comparing the captured material identifier uniquely assigned to one specific manufacturing-site material container 440 with a previously recorded identifier uniquely assigned to the manufacturing-site material container 440, and using the data associated with a status of replenishment to (i) update material quantity information assigned to the manufacturing-site if the identifiers match, or (ii) trigger an alarm signal if the identifiers differ from each other.

Example 8 may include the method according to any one of the preceding example, further comprising: monitoring a quantity of the material taken from the manufacturing-site material container 440.

Example 9 may include the method according to any one of the preceding examples, further comprising: predicting the quantity of material expected to be required over a specified or determinable period of time, depending on at least one of: (i) material usage information of one or more further scheduled jobs, (ii) material usage information of past usage of a present user, and/or (iii) material usage information of past usage of at least one reference user.

Example 10 may include the method according to any one of the preceding examples, further comprising: obtaining data associated with a manufacturing-site stock quantity of material available for replenishment.

Example 11 may include the method according to example 10, further comprising: triggering an order of an additional stock quantity of manufacturing-site material dependent from the obtained data associated with the stock quantity of material available for replenishment.

Example 12 may include a computer-implemented method of providing production material, comprising: providing, to one or more of the processing units 312, 422, data associated with a manufacturing-site material container 440, obtaining, in response to the provided data associated with the manufacturing-site material container 440, data at least adapted to trigger replenishment instructions dependent from a determination of a quantity of material available in the manufacturing-site material container 440.

Example 13 may include the method according to example 12, further comprising: capturing data associated with a replenishment of the manufacturing-site material container 440, the captured data at least associated with a material identifier at least indicating a type of the replenished material, and providing the captured data.

Example 14 may include a computing device, comprising means for carrying out the method of any one of examples 1 to 11 or 12 to 13.

Example 15 may include a computer program product comprising instructions, which, when the program is executed by a computing device, cause the computing device to carry out the method of any one of examples 1 to 11 or 12 to 13.

It is noted that embodiments of the invention are described with reference to different subject-matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items recited in the claims. The mere fact that certain measures are re-cited in mutually different dependent claims does not indicate that a combination of these measures cannot be used to advantage. Any reference signs in the claims should not be construed as limiting the scope.

1. A method of manufacturing an insulated member (500), comprising the steps of:
providing, to a computing cloud (310), geometric data of at least a section of a raw part (501) having at least one application section to be applied with an insulation material (502),
determining, using the computing cloud (310), on the basis of the geometric data, a movement data for a relative movement between a manufacturing site applicator (410), adapted to apply the insulation material (502) onto the application section of the raw part (501),
determining, using the computing cloud (310), an amount of the insulation material (502) for applying onto the application section,
generating, using the computing cloud (310), a control data set at least comprising the movement data and the amount of insulation material (502), and
providing the control data set to a manufacturing site (400) that is remote to the computing cloud (310) and/or a planning site where said geometric data is generated.

2. The method according to claim 1, further comprising the step of:
controlling, by the control computer (420), the relative movement between the manufacturing site applicator (410) and the raw part (501) and of the application of the insulation material (502) on basis of the control data set.

3. The method according to claim 1, wherein, using the computing cloud (310), the required amount of insulation material (502) is determined based on a desired insulation value of the finalized insulated member (500).

4. The method according to claim 1, wherein, via at least one user interface associated with the computing cloud (310), the insulation value and/or an insulation material type is input, and wherein the computing cloud (310) determines an insulation material thickness on the basis of the input insulation value and/or insulation material type.

5. The method according to claim 1, wherein the control data set is queued in the computing cloud (310), and wherein, via a user interface associated with the computing cloud (310), an order and/or content of the queue comprising at least one further data set is changeable.

6. The method according to claim 5, wherein, using the computing cloud (310), a total amount of insulation material (502) required is estimated or determined on basis of the queue.

7. The method according to claim 5, wherein, using the computing cloud (310), a total processing time of at least applying the insulation material (502) onto the application section is estimated or determined on the basis of the queue.

8. The method according to claim 1, wherein during application of the insulation material (502) process data is collected in a process data (451) set by a manufacturing site process monitoring means (450).

9. The method according to claim 8, wherein an amount of the insulation material (502) already applied onto the application section is determined dynamically on the basis of the process data set (451).

10. The method according to claim 8, wherein utilization and/or costs of the insulation material (502) applied to the application section is determined dynamically on the basis of the process data set (451).

11. The method according to claim 1, wherein, using the computing cloud (310), a material logistics system is triggered to order a stock quantity of material.

12. The method according to claim 1, wherein the computing cloud (310) comprises an artificial-intelligence-module (314), AI-module, and wherein the AI-module (314) performs at least determination tasks and/or estimation tasks of the computing cloud.

13. The method according to claim 1, wherein the computing cloud (310) and at least the control computer are operated in a first operating mode, in which there is a data connection between the first and the second data processing means and an application robot is at least controlled via the computing cloud (310) and the control computer, or in a second operating mode, in which a data connection between the first and the second data processing means is interrupted, at least the controlling data set is cached at the control computer and the application robot is controlled on the basis of the cached control data set.

14. A computing cloud (310) for manufacturing an insulated member (500), comprising:
a first data interface adapted to at least obtain data associated with the insulated member, provided by at least one user interface of a manufacturing planning site,
a first data processing unit adapted to process the obtained data associated with the insulated member to determine geometric data of a raw part to be applied with an insulation material, to determine a movement data associated with the application of the insulation material onto at least a section of the raw part and to determine an amount of the insulation material to be applied onto the application section, and adapted to generate a control data set, and
a second data interface adapted to at least provide the control data set to a manufacturing site applicator adapted to process the control data set to apply the insulation material onto the application section.

15. A manufacturing-site applicator (410) for manufacturing an insulated member (500), comprising:
a control computer (420) having a third data interface adapted to at least obtain a control data set by a computing cloud, and a second data processing unit adapted to process the obtained control data set comprising at least geometric data of a raw part to be applied with a insulation material, movement data associated with the application of the insulation material onto at least a section of the raw part and amount data of the insulation material to be applied onto the application section, and
an application robot (430) adapted to be controlled by the control computer on the basis of the control data set and to apply the insulation material onto the application section.

16. A system (100) for manufacturing an insulated member (500), comprising:
a computing cloud (310) according to claim 14 and
a manufacturing site applicator (410) for manufacturing an insulated member (500), comprising:
a control computer (420) having a third data interface adapted to at least obtain a control data set by a computing cloud, and a second data processing unit adapted to process the obtained control data set comprising at least geometric data of a raw part to be applied with a insulation material, movement data associated with the application of the insulation material onto at least a section of the raw part and amount data of the insulation material to be applied onto the application section, and
an application robot (430) adapted to be controlled by the control computer on the basis of the control data set and to apply the insulation material onto the application section, which is at least temporarily connectable to the computing cloud (310).

17. A computer program element for manufacturing an insulated member (500), the program, when being executed by a processing unit, is adapted for carrying out the method according to claim 1.
